(19) United States
(12) Patent Application Publication
(10) Pub. No.: US 2014/0261701 A1
(43) Pub. Date: Sep. 18, 2014

(54) Collapsible Air Duct with Inflatable Insulative Sleeve

(71) Applicant: Mark Deutsch, Arlington Heights, IL (US)

(72) Inventor: Mark Deutsch, Arlington Heights, IL (US)

(21) Appl. No.: 13/839,730

(22) Filed: Mar. 15, 2013

(51) Int. Cl. F24F 13/02; B64F 1/36

(52) U.S. Cl. CPC F24F 13/0218; F24F 13/0272; B64F 1/364
USPC 137/1; 138/119; 138/134

(57) ABSTRACT

A collapsible air duct with inflatable insulative sleeve for supplying preconditioned air from a remote source to aircraft and similar vehicles. The system includes first annular interior chamber substantially surrounded by an a non-rigid inflatable sleeve which provides a thermal barrier from adverse environmental conditions. The non-rigid inflatable sleeve is filled by a portion of the air supply transiting the annular interior chamber through a series of perforations, thus providing an insulative air layer.

### FIELD OF INVENTION

The present invention relates to a system and method for more efficient supply of conditioned air from a ground based air conditioning unit to an aircraft or similar vehicle. Specifically, the present invention relates to a duct or hose with a collapsible insulative layer which nonetheless reduces thermal bleed into a central air stream being transported from the air conditioning unit to the parked aircraft. The system preferably includes a. Thus, a system and method for improving the efficiency of supplying conditioned air to a parked aircraft is disclosed.

### BACKGROUND OF THE INVENTION

Modern civil aviation entails the maintenance and transition of aircraft in a variety environments. Specifically, aircraft are involved in layovers and maintenance work in variety of locations and extreme temperatures which necessitate the need for a steady supply of conditioned air while the aircraft is stopped. As a result, the equipment for supplying such air to the aircraft may itself absorb heat such that the temperature of the airstream being supplied is impacted while the aircraft is stopped.

Similarly, when such aircraft servicing equipment is not in use, the equipment may unduly heat and/or cool while being exposed to the elements. Thus, the equipment, even if insulated, may become heated so as to defeat the efficacy of the conditioned air stream being delivered.

Furthermore, the distributed nature of modern airports often includes the stoppage and servicing of aircraft at a location remote from any sheltered stopping point. In addition, the ambient conditions at such sites may preclude long term exposure of such equipment to the elements.

Thus, the present state of the art reflects a need for collapsible air duct with an inflatable insulative sleeve for use with supplying conditioned air for aircraft and similar equipment, wherein a portion of the air stream being supplied to the aircraft inflates the insulative sleeve, and the insulative sleeve may be collapsed for compact stowage when not in use.

### DESCRIPTION OF THE PRIOR ART

One example of a prior art approach is found in U.S. Pat. No. 7,322,203 (Widegren) which discloses generally a portable device for supplying preconditioned air to an aircraft on the ground. Widegren discloses generally a device including a connection hose for connecting to an aircraft on one end, and a mixing chamber on a second end for connection to a mixing chamber for receiving cool conditioned air from an expansion chamber mixed with ambient air. Widegren, however, fails to account for the aforementioned problems of thermal leaking from the connection hose, as well as thermal buildup from have the portal device exposed to the elements.

Another discussion of a prior art approach may be found in U.S. Pat. No. 6,051,291 (Gladfelter et al.) which purports to teach a heat reflective sleeve with an insulating air pocket. Specifically, Gladfelter et al. discusses the use of relflective sleeving for thermal insulation of insulative sleeving for use in aircraft applications (among other uses). Gladfelter et al., however, requires the use of multiple sheets of thermally insulating material, such as glass fiber yarns, and appears to be directed towards permanently connected hoses on aircraft and similar vehicles (e.g., brake lines).

What is needed is simple, portable structure for providing conditioned air to an aircraft or similar structure when parked, which is nonetheless cost effective and collapsible for compact storage when not in use.

### DEFINITION OF TERMS

The following terms are used in the claims of the patent as filed and are intended to have their broadest plain and ordinary meaning consistent with the requirements of the law.

A “collapsible air duct” is a hose, sleeve, or similar connector extending between an aircraft or similar vehicle on one end, and an conditioned air supply remote from the aircraft or similar vehicle on the other end. This structure further must have a structure design for collapse and storage when not in use.

A “non-rigid insulative sleeve” is a structure which, when deployed, provides an insulative layer for a conditioned air layer, wherein the insulative layer is air, preferably air which is diverted from a portion of the conditioned air supply being provided to the aircraft or other vehicle. The “non-rigid insulative sleeve” is inflated by the pressure of the air being supplied, and thus deflates and collapses for storage when not in use.

A “first annular interior chamber” is the pathway for conditioned air being supplied from the conditioned air supply to the aircraft or other vehicle. It is axially to the interior of the “non-rigid insulative sleeve.”

A perforation is at least one hole or opening defined between the first annular interior chamber and the non-rigid insulative sleeve.

Where alternative meanings are possible, the broadest meaning is intended. All words used in the claims set forth below are intended to be used in the normal, customary usage of grammar and the English language.

### OBJECTS AND SUMMARY OF THE INVENTION

The apparatus and method of the present invention generally includes a collapsible air duct with an insulative sleeve for supplying air to a vehicle, such as an aircraft parked for layover, maintenance or the like. The collapsible air duct includes a first end for connecting to an air supply (e.g., an air conditioning outlet) remote from the vehicle, and a second end for connection to the vehicle. The device includes a first annular interior chamber for transiting air from the air supply equipment to the vehicle, and a non-rigid insulative sleeve generally surrounding the annular interior chamber. The insulative sleeve includes one or more perforations such that a portion of the air being supplied from the air conditioning unit to the aircraft is diverted from the annular interior chamber to the non-rigid insulative sleeve, thereby permitting such air to act as an insulative barrier and preventing the undue ambient thermal impact on the air passing through the annular interior chamber to the aircraft. In addition, the use of such air permits the air duct to collapse upon disengaging from the aircraft, thereby permitting the air duct to be folded or coiled and stored in a compact fashion (e.g., in a recess container on the airfield in the case of a location far from a hangar or other shelter).

The immediate application of a present invention will be seen in providing a collapsible sleeve enabling a supply of conditioned air for an aircraft or other vehicle, though those of skill will see that the present invention could be applied to other fields requiring using a collapsible air duct with an insulated sleeve for delivery of conditioned air.

Thus can be seen that one object of the present invention is to provide an air duct for air conditioning which can be disengaged and collapsed when not in use.

A further object of the present invention is to provide an air duct for air conditioning with an insulative layer which may be easily removed upon disuse so as to permit compact storage.

Still another object of the present invention is to provide an air duct wherein the insulative layer is provided by a portion of the air stream being supplied.

Yet another object of the present invention is to provide an air duct with a wire, mesh or similar collapsible frame upon disengagement.

Still another object of the present invention is to provide a portable, collapsible air duct which reduces or eliminates the thermal effects of extreme temperatures on an air stream being transferred from a remote air supply unit.

It should be noted that not every embodiment of the claimed invention will accomplish each of the objects of the invention set forth above. In addition, further objects of the invention will become apparent based the summary of the invention, the detailed description of preferred embodiments, and as illustrated in the accompanying drawings. Such objects, features, and advantages of the present invention will become more apparent in light of the following detailed description of a best mode embodiment thereof, and as illustrated in the accompanying drawings.

### BRIEF DESCRIPTION OF THE DRAWINGS

FIGS. 1a and 1b shows side and end views, respectively, of a first preferred embodiment of the invention employing a lay flat configuration.

FIG. 2 shows a perspective view of a first preferred embodiment of the invention employing a lay flat configuration.

FIG. 3 shows an exposed, transverse view a first preferred embodiment of the invention employing a lay flat configuration.

FIG. 4 shows a perspective view of a second preferred embodiment of the invention using a configuration with a self supporting hose and wear strip.

FIG. 5 shows a perspective view of a third preferred embodiment of the invention using a configuration with a self supporting hose with a spiral wire and wear strip.

### DETAILED DESCRIPTION OF THE INVENTION

Set forth below is a description of what is currently believed to be the preferred embodiment or best examples of the invention claimed. Future and present alternatives and modifications to this preferred embodiment are contemplated. Any alternatives or modifications which make insubstantial changes in function, in purpose, in structure or in result are intended to be covered by the claims in this patent.

FIGS. 1a and 1b show a first preferred embodiment of collapsible air supply hose assembly 10 constructed in accordance with the present invention using an end view and a side view, respectively. The air supply hose assembly is adapted to be brought next to a parked aircraft, in order to supply the aircraft with preconditioned air, i.e., cool air, to maintain the passenger cabin at comfortable temperature levels. The assembly 10 includes a first or main annular chamber 12 which connects an air conditioning unit (not shown) or other air supply port to a vehicle (also not shown). Alternatively, the hose assembly 10 may connect to a similar assembly, which in turn connects to a vehicle. Surrounding or exterior to the first annular chamber is one or more inflation chambers 14 which provide a sleeve generally surrounding the main annular chamber 12. The materials for the inflation chambers may be Nylon and/or coated polyester, as understood by those of ordinary skill in the art. The assembly connects to the air conditioning unit port and vehicle through a first end cuff 16 and a second end cuff 18, respectively. As those of skill in the art will know, such cuffs 16, 18 can be attached to aircraft or air conditions units through zipper, clamp, Velcro or similar mechanisms (not shown). The inflation chambers 14 may vary in number, though in this first preferred embodiment there are four such inflation chambers 14 extending along the length of the main annular chamber 12, with each such chamber extending radially around an approximate 90 degree arc of the circumference of the main annular chamber.

In this first preferred embodiment, the sole insulation is provided by a portion of the air flow transiting the main annular chamber 12. A portion of that air stream is diverted from the main annular chamber to the inflation chambers 14 via air passage holes 20 or apertures located in each of the inflation chambers 14 which enable a portion of the pressurized conditioned air stream to inflate the inflation chambers 14. Ideally, it is believed that a given inflation chamber should have about four holes per foot of annular chamber length in the collapsible air supply hose assembly 10 As a result of the air displaced through these holes 20, the air contained within the inflation chambers 14 acts as an insulator to absorb any ambient temperature gradient between the temperature of the conditioned air and outside air.

The air received within the inflation chambers 14 is believed to be delayed or retained in the inflation chambers (as opposed to transiting back through the main annular chamber to the aircraft) because of the nature of the connection between the cuff and the aircraft or air conditioning unit. Namely, as detailed in FIG. 2 the ends of the inflation chambers 14 are welded or other closed by attachment to the main annular chamber 12 at each end of the annular chamber, and the cuffs 16, 18 are connected to the main annular chamber 12 via stitching or similar suitable connection. Thus, only the main annular chamber 12, and not the inflation chambers 14 have direct fluid communication with the aircraft, which in turn deters the possibility of insulating air leaking back from the inflation chambers 14 into the annular chamber 12 and into the aircraft. Furthermore, as shown in FIG. 3, the insulating air containing within the inflation chambers 14 is further restricted through the use of chamber welds 22 running along the length of the annular chamber 12 and separating the inflation chambers 14 from one another. Such welds are preferable about 1.0″ in width, plus or minus 0.5″. This weld limitation on the ability of the insulating air to rotate radially provides a cushion in almost any radial directions. Thus, the placement of the collapsible air supply hose assembly 10 on the ground during operation does not “push” insulating air away such that thermal energy conduction from the ground does not directly heat the annular chamber 12.

A second preferred embodiment of the present invention is shown in FIG. 4. This embodiment alters the path of the inflation chamber 14 in relationship to the length of the annular chamber 12. That is, the inflation chambers 14 wind helically along the length of the annular chamber 12. Furthermore, in lieu of the chamber welds 22 of the first embodiment, this second embodiment uses a helical wear strip 28 wraps around the exterior of the inflation chambers 14 to prevent undue abrasion on the collapsible air supply hose assembly 10. The components are attached to one another via continuous stitching 30 which extends through each of the wear strip 28, the inflation chambers 14, and the annular chamber 12.

A third preferred embodiment of the present invention in shown in FIG. 5. This embodiment is a variant on the second embodiment whereby the structural integrity of the collapsible air supply hose assembly 10 is further reinforced by a helical steel wire 32 which winds around the wall of the annular chamber 12. In practice, this embodiment, unlike the first and second embodiments, would not lay flat upon disuse, and thus would like entail a different form of storage, though in each of the embodiments the inflation chambers would deflate after use.

The above description is not intended to limit the meaning of the words used in the following claims that define the invention. Rather, it is contemplated that future modifications in structure, function or result will exist that are not substantial changes and that all such insubstantial changes in what is claimed are intended to be covered by the claims. For instance, the numbers of inflation chambers 14 used in the preferred embodiments of present invention is for illustrative purposes with reference to the example drawings only. Similarly, while the wear strips 28 of certain preferred embodiments of the present invention are focused upon their attachment to the inflation chambers 14 and the annular chamber 12, those of skill will understand the applicability of the present invention to configurations whereby such solely to the inflation chamber 14 through separate stitching and attachment from the stitching connecting the annular chamber 12 to the inflation chambers 14. Likewise, it will be appreciated by those skilled in the art that various changes, additions, omissions, and modifications can be made to the illustrated embodiments without departing from the spirit of the present invention. All such modifications and changes are intended to be covered by the following claims.

I claim:

1. A collapsible air duct with an inflatable insulative sleeve comprising;
a) A first annular interior chamber defined by an non-rigid interior barrier, the interior chamber having a first inlet end for connection to an air conditioning system and the second outlet end for connection to an aircraft;
b) A non-rigid insulative sleeve comprising a second concentric chamber surrounding the first annular interior chamber, the exterior surface of the non-rigid insulative sleeve being generally gas impermeable and surrounding the circumference of the inflatable interior barrier, and the interior of the insulative sleeve defined by the inflatable interior barrier; and
c) At least one perforation on the interior barrier to provide air pressure to inflate the inflatable insulative sleeve.

2. The collapsible air duct of claim 1, further comprising a deformable helical wire support extending along the length of the interior barrier.

3. The collapsible air duct of claim 1, further comprising a plurality of perforations generally evenly spaced along the length of the interior barrier.

4. The collapsible air duct of claim 1, further comprising a plurality of perforations generally evenly spaced around the circumference of the interior barrier.

5. The collapsible air duct of claim 1, wherein the first inlet end of the first annular interior chamber comprises a band clamp.

6. The collapsible air duct of claim 5, wherein the opening to the band clamp is directly connected solely to the first annular interior chamber.

7. The collapsible air duct of claim 5, wherein the band clamp comprises a plenum to communicate air directly to the first annular interior chamber and the non-rigid insulative sleeve.

8. The collapsible air duct of claim 1, wherein the structural in situ rigidity of the non-rigid insulative sleeve consists of air received from the perforation of the interior barrier.

9. The collapsible air duct of claim 1, wherein the exterior surface of the non-rigid insulative sleeve includes at least one fluid evacuation port for permitting the escape of water and water vapor from the non-rigid insulative sleeve.

10. The collapsible air duct of claim 1, wherein the exterior surface of the non-rigid insulative sleeve comprises a deformable wear strip.

11. The collapsible air duct of claim 1, wherein the exterior surface of the non-rigid insulative sleeve and the inflatable interior barrier connect solely at the first inlet end and second outlet end.

12. A method for supplying conditioned air to a grounded aircraft, the method comprising the steps of:
a) stretching a collapsible air duct to a grounded aircraft, the air duct having a first end and a second end and a first annular chamber and a second insulating chamber, the first end being connected to an air conditioning unit;
b) extend the second end of the collapsible air duct towards a grounded aircraft;
c) supplying air from the air conditioning unit through the first annular chamber to the aircraft; and
d) supplying air from the first annular chamber to the second insulating chamber through at least one perforation therebetween;
whereby the insulating chamber provides a collapsible, lightweight thermal barrier for air supplied to the grounded aircraft.
